(19) United States
(12) Patent Application Publication
(10) Pub. No.: US 2022/0092985 A1
(43) Pub. Date: Mar. 24, 2022

(54) VARIABLE THRESHOLD FOR IN-PATH OBJECT DETECTION

(71) Applicant: GM GLOBAL TECHNOLOGY OPERATIONS LLC, Detroit, MI (US)

(72) Inventors: Tommy V. Beetham, Brighton, MI (US); Robert C. Barazu, Livonia, MI (US)

(73) Assignee: GM GLOBAL TECHNOLOGY OPERATIONS LLC, Detroit, MI (US)

(21) Appl. No.: 17/031,237

(22) Filed: Sep. 24, 2020

(51) Int. Cl. G08G 1/16; G05D 1/00; G08G 1/137

(52) U.S. Cl. CPC G08G 1/166; G08G 1/167; G05D 2201/0213; G05D 1/0088; G08G 1/137; G08G 1/165

(57) ABSTRACT

Systems and methods are provided for controlling a vehicle. In one embodiment, a method includes: receiving, by a processor, real-time lane width data based on a current location of the vehicle; computing, by the processor, an in-path threshold based on the real-time lane width; receiving, by the processor, real-time distance data based on a distance between a center of the vehicle and a lane edge; computing, by the processor, an offset value based on the real-time distance data; applying, by the processor, the offset value to the in-path threshold; tracking, by the processor, a position of objects within the field of view of the vehicle sensor system based on the in-path threshold; and controlling, by the processor, the vehicle based on the tracking of the objects.

### INTRODUCTION

The present disclosure generally relates to vehicles, and more particularly relates to in-path object detection based on dynamic thresholds.

An autonomous vehicle is a vehicle that is capable of sensing its environment and navigating with little or no user input. An autonomous vehicle senses its environment using sensing devices such as radar, lidar, image sensors, and the like. The autonomous vehicle system further uses information from global positioning systems (GPS) technology, navigation systems, vehicle-to-vehicle communication, vehicle-to-infrastructure technology, and/or drive-by-wire systems to navigate the vehicle.

While autonomous vehicles and semi-autonomous vehicles offer many potential advantages over traditional vehicles, in certain circumstances it may be desirable for improved operation of the vehicles. For example, autonomous vehicle systems detect traffic objects in the path of the vehicle and control the vehicle by braking, accelerating, swerving, turning, etc. These systems assign a lane to the object and the host vehicle based on a proximity to a fixed lane width along the vehicle path of approximately 3.6 meters. When operating on narrow city streets, a 3.6 meter vehicle path can intrude into adjacent lanes, causing some objects to be assigned to the host vehicle's lane. The host vehicle may then be controlled based on objects that are not in their lane or path.

Accordingly, it is desirable to provide improved systems and methods for detecting the lane of an object. It is further desirable to provide improved systems and method for detecting the lane based on dynamic lane thresholds. Furthermore, other desirable features and characteristics of the present disclosure will become apparent from the subsequent detailed description and the appended claims, taken in conjunction with the accompanying drawings and the foregoing technical field and background.

### SUMMARY

Systems and methods are provided for tracking object lane assignments. In one embodiment, a method includes: receiving, by a processor, real-time lane width data based on a current location of the vehicle; computing, by the processor, an in-path threshold based on the real-time lane width; receiving, by the processor, real-time distance data based on a distance between a center of the vehicle and a lane edge; computing, by the processor, an offset value based on the real-time distance data; applying, by the processor, the offset value to the in-path threshold; tracking, by the processor, a position of objects within the field of view of the vehicle sensor system based on the in-path threshold; and controlling, by the processor, the vehicle based on the tracking of the objects.

In various embodiments, the real-time lane width data is received from a camera of the vehicle.

In various embodiments, the real-time lane width data is received from a data storage device of the vehicle that stores map data.

In various embodiments, the computing the offset value is further based on an offset ratio and the real-time lane width data.

In various embodiments, the method further includes computing the offset ratio based on a maximum lane width and a real-time lane width; and applying the offset ratio to the real-time distance data to compute the offset value.

In various embodiments, the method further includes subtracting half of the real-time lane width data from offset value.

In various embodiments, the method further includes computing the offset ratio based on a minimum lane width and a real-time lane width; and applying the offset ratio to the real-time distance data to compute the offset value.

In various embodiments, the method further includes limiting the in-path threshold based on a predefined hysteresis.

In various embodiments, the applying the offset value to the in-path threshold comprises subtracting the offset value from a left in-path threshold.

In various embodiments, the applying the offset value to the in=path threshold comprises adding the offset value to a right in-path threshold.

A another embodiment a system includes: a sensor system configured to provide sensor data that includes real-time lane width data; a data storage system configured to provide map data that includes real-time lane width data; and a processor configured to receive real-time lane width data based on a current location of the vehicle from at least one of the sensor system and the data storage system, compute an in-path threshold based on the real-time lane width, receive real-time distance data based on a distance between a center of the vehicle and a lane edge, compute an offset value based on the real-time distance data, apply the offset value to the in-path threshold, track a position of objects within the field of view of the vehicle sensor system based on the in-path threshold, control the vehicle based on the tracking of the objects.

In various embodiments, the real-time lane width data is received from a camera of the sensor system.

In various embodiments, the real-time lane width data is received from a data storage system.

In various embodiments, the processor computes the offset value is further based on an offset ratio and the real-time lane width data.

In various embodiments, the processor is further configured to compute the offset ratio based on a maximum lane width and a real-time lane width; and applying the offset ratio to the real-time distance data to compute the offset value.

In various embodiments, the processor is further configured to subtract a half of the real-time lane width data from offset value.

In various embodiments, the processor is further configured to compute the offset ratio based on a minimum lane width and a real-time lane width; and applying the offset ratio to the real-time distance data to compute the offset value.

In various embodiments, the processor is further configured to limit the in-path threshold based on a predefined hysteresis.

In various embodiments, the applying the offset value to the in-path threshold includes subtracting the offset value from a left in-path threshold.

In various embodiments, the processor applies the offset value to the in-path threshold by adding the offset value to a right in-path threshold.

### BRIEF DESCRIPTION OF THE DRAWINGS

The exemplary embodiments will hereinafter be described in conjunction with the following drawing figures, wherein like numerals denote like elements, and wherein:

FIG. 1 is a functional block diagram illustrating an autonomous vehicle having an object tracking system, in accordance with various embodiments;

FIG. 2 is a dataflow diagram illustrating an autonomous driving system that includes the object tracking system, in accordance with various embodiments;

FIG. 3 is a dataflow diagram illustrating an object tracking system, in accordance with various embodiments; and

FIG. 4 is a flowchart illustrating an object tracking method that may be performed by the object tracking system, in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments of the present disclosure may be practiced in conjunction with any number of systems, and that the systems described herein is merely exemplary embodiments of the present disclosure.

For the sake of brevity, conventional techniques related to signal processing, data transmission, signaling, control, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

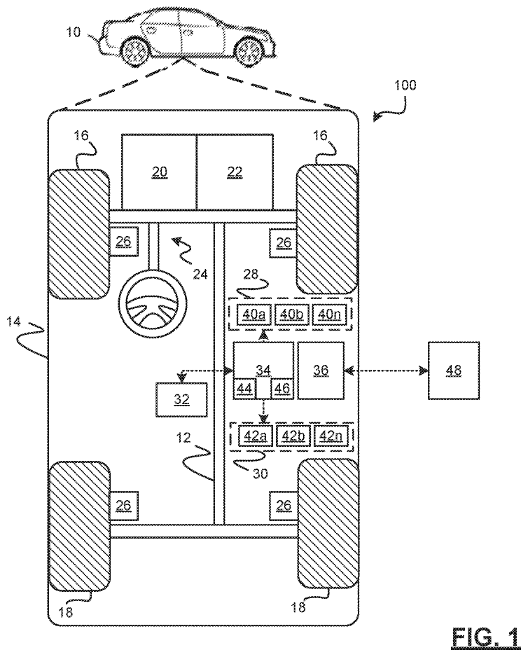

With reference to FIG. 1, an object tracking system shown generally at 100 is associated with a vehicle 10 in accordance with various embodiments. In general, the object tracking system 100 processes data provided by one or more sensing devices disposed about the vehicle 10 or processes map data to predict an actual lane width of lanes associated with a current position of the vehicle 10. The object tracking system 100 then uses the predicted lane width to locate a lateral position of the vehicle 10 (referred to as the host vehicle) and a determine when an object is in the path of the vehicle 10. In various embodiments, the vehicle 10 uses the host vehicle position and the object positions to make decisions about navigating the vehicle 10 through the environment.

As depicted in FIG. 1, the vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14.

In various embodiments, the vehicle 10 is an autonomous vehicle and the object tracking system 100 is incorporated into the autonomous vehicle 10 (hereinafter referred to as the autonomous vehicle 10). The autonomous vehicle 10 is, for example, a vehicle that is automatically controlled to carry passengers from one location to another. The vehicle 10 is depicted in the illustrated embodiment as a passenger car, but it should be appreciated that any other vehicle including motorcycles, trucks, sport utility vehicles (SUVs), recreational vehicles (RVs), or simply robots, etc., that are regulated by traffic devices can also be used. In an exemplary embodiment, the autonomous vehicle 10 is a so-called Level Four or Level Five automation system. A Level Four system indicates “high automation”, referring to the driving mode-specific performance by an automated driving system of all aspects of the dynamic driving task, even if a human driver does not respond appropriately to a request to intervene. A Level Five system indicates “full automation”, referring to the full-time performance by an automated driving system of all aspects of the dynamic driving task under all roadway and environmental conditions that can be managed by a human driver. As can be appreciated, in various embodiments, the autonomous vehicle 10 can be any level of automation or have no automation at all (e.g., when the system 100 simply presents the probability distribution to a user for decision making).

As shown, the autonomous vehicle 10 generally includes a propulsion system 20, a transmission system 22, a steering system 24, a brake system 26, a sensor system 28, an actuator system 30, at least one data storage device 32, at least one controller 34, and a communication system 36. The propulsion system 20 may, in various embodiments, include an internal combustion engine, an electric machine such as a traction motor, and/or a fuel cell propulsion system. The transmission system 22 is configured to transmit power from the propulsion system 20 to the vehicle wheels 16-18 according to selectable speed ratios. According to various embodiments, the transmission system 22 may include a step-ratio automatic transmission, a continuously-variable transmission, or other appropriate transmission. The brake system 26 is configured to provide braking torque to the vehicle wheels 16-18. The brake system 26 may, in various embodiments, include friction brakes, brake by wire, a regenerative braking system such as an electric machine, and/or other appropriate braking systems. The steering system 24 influences a position of the of the vehicle wheels 16-18. While depicted as including a steering wheel for illustrative purposes, in some embodiments contemplated within the scope of the present disclosure, the steering system 24 may not include a steering wheel.

The sensor system 28 includes one or more sensing devices 40a-40n that sense observable conditions of the exterior environment and/or the interior environment of the autonomous vehicle 10. The sensing devices 40a-40n can include, but are not limited to, radars, lidars, global positioning systems, optical cameras, thermal cameras, ultrasonic sensors, inertial measurement units, and/or other sensors. In various embodiments, the sensing devices 40a-40n include one or more image sensors that generate image sensor data that is used by the interpretation system 100.

The actuator system 30 includes one or more actuator devices 42a-42n that control one or more vehicle features such as, but not limited to, the propulsion system 20, the transmission system 22, the steering system 24, and the brake system 26. In various embodiments, the vehicle features can further include interior and/or exterior vehicle features such as, but are not limited to, doors, a trunk, and cabin features such as air, music, lighting, etc.

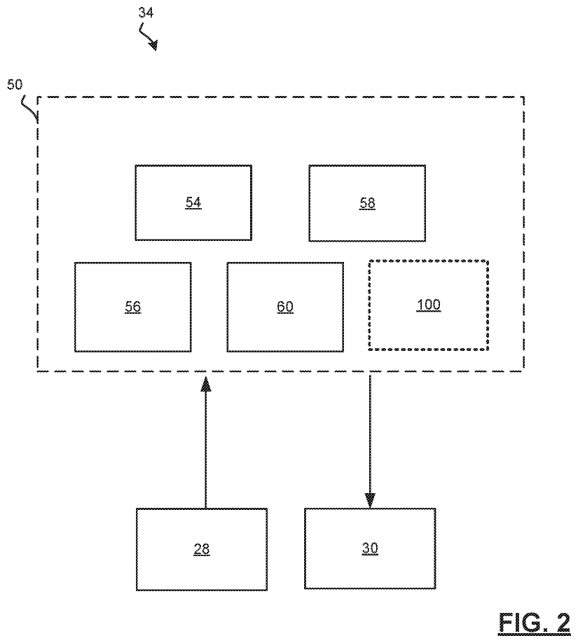

The communication system 36 is configured to wirelessly communicate information to and from other entities 48, such as but not limited to, other vehicles (“V2V” communication,) infrastructure (“V2I” communication), remote systems, and/or personal devices (described in more detail with regard to FIG. 2). In an exemplary embodiment, the communication system 36 is a wireless communication system configured to communicate via a wireless local area network (WLAN) using IEEE 802.11 standards or by using cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

The data storage device 32 stores data for use in automatically controlling the autonomous vehicle 10. In various embodiments, the data storage device 32 stores defined maps of the navigable environment. In various embodiments, the defined maps are built from the sensor data of the vehicle 10. In various embodiments, the maps are received from a remote system and/or other vehicles. As can be appreciated, the data storage device 32 may be part of the controller 34, separate from the controller 34, or part of the controller 34 and part of a separate system.

The controller 34 includes at least one processor 44 and a computer readable storage device or media 46. The processor 44 can be any custom made or commercially available processor, a central processing unit (CPU), a graphics processing unit (GPU), an auxiliary processor among several processors associated with the controller 34, a semiconductor based microprocessor (in the form of a microchip or chip set), a macroprocessor, any combination thereof, or generally any device for executing instructions. The computer readable storage device or media 46 may include volatile and nonvolatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the autonomous vehicle 10.

The instructions may include one or more separate programs, each of which comprises an ordered listing of executable instructions for implementing logical functions. The instructions, when executed by the processor 44, receive and process signals from the sensor system 28, perform logic, calculations, methods and/or algorithms for automatically controlling the components of the autonomous vehicle 10, and generate control signals to the actuator system 30 to automatically control the components of the autonomous vehicle 10 based on the logic, calculations, methods, and/or algorithms. Although only one controller 34 is shown in FIG. 1, embodiments of the autonomous vehicle 10 can include any number of controllers 34 that communicate over any suitable communication medium or a combination of communication mediums and that cooperate to process the sensor signals, perform logic, calculations, methods, and/or algorithms, and generate control signals to automatically control features of the autonomous vehicle 10.

In various embodiments, one or more instructions of the controller 34 are embodied in the object tracking system 100 and, when executed by the processor 44, integrates real time information from the sensing devices 28 and/or map information from the data storage device and outputs an object lane assignment based thereon. The instructions of the controller 34 further make use of these lane assignments in making decisions for and planning upcoming vehicle maneuvers used to navigate the vehicle 10 through the environment.

As can be appreciated, the controller 34 may be implemented as multiple controllers including at least one residing on the vehicle and at least one residing remote from the vehicle. In such embodiments, functions of the object tracking system 100 may implemented on any of the controllers 34, including partially on a first controller of the vehicle and partially on a second controller residing for example on a server system.

As can be appreciated, the subject matter disclosed herein provides certain enhanced features and functionality to what may be considered as a standard or baseline non-autonomous vehicle or an autonomous vehicle 10, and/or an autonomous vehicle based remote transportation system (not shown) that coordinates the autonomous vehicle 10. To this end, a non-autonomous vehicle, an autonomous vehicle, and an autonomous vehicle based remote transportation system can be modified, enhanced, or otherwise supplemented to provide the additional features described in more detail below. For exemplary purposes the examples below will be discussed in the context of an autonomous vehicle.

In accordance with various embodiments, the controller 34 implements an autonomous driving system (ADS) 50 as shown in FIG. 2. That is, suitable software and/or hardware components of the controller 34 (e.g., the processor 44 and the computer-readable storage device 46) are utilized to provide an autonomous driving system 50 that is used in conjunction with vehicle 10.

In various embodiments, the instructions of the autonomous driving system 50 may be organized by function, module, or system. For example, as shown in FIG. 2, the autonomous driving system 50 can include a computer vision system 54, a positioning system 56, a guidance system 58, and a vehicle control system 60. As can be appreciated, in various embodiments, the instructions may be organized into any number of systems (e.g., combined, further partitioned, etc.) as the disclosure is not limited to the present examples.

In various embodiments, the computer vision system 54 synthesizes and processes sensor data and predicts the presence, location, classification, and/or path of objects and features of the environment of the vehicle 10. In various embodiments, the computer vision system 54 can incorporate information from multiple sensors, including but not limited to cameras, lidars, radars, and/or any number of other types of sensors.

The positioning system 56 processes sensor data along with other data to determine a position (e.g., a local position relative to a map, an exact position relative to lane of a road, vehicle heading, velocity, etc.) of the vehicle 10 relative to the environment. The guidance system 58 processes sensor data along with other data to determine a path for the vehicle 10 to follow. The vehicle control system 60 generates control signals for controlling the vehicle 10 according to the determined path.

In various embodiments, the controller 34 implements machine learning techniques to assist the functionality of the controller 34, such as feature detection/classification, obstruction mitigation, route traversal, mapping, sensor integration, ground-truth determination, and the like.

In various embodiments, the object tracking system 100 of FIG. 1 may be included within the ADS 50. For example, the object tracking system 100 receives data from the computer vision system 54, the positioning system 56, and provides object tracking data to the guidance system 58.

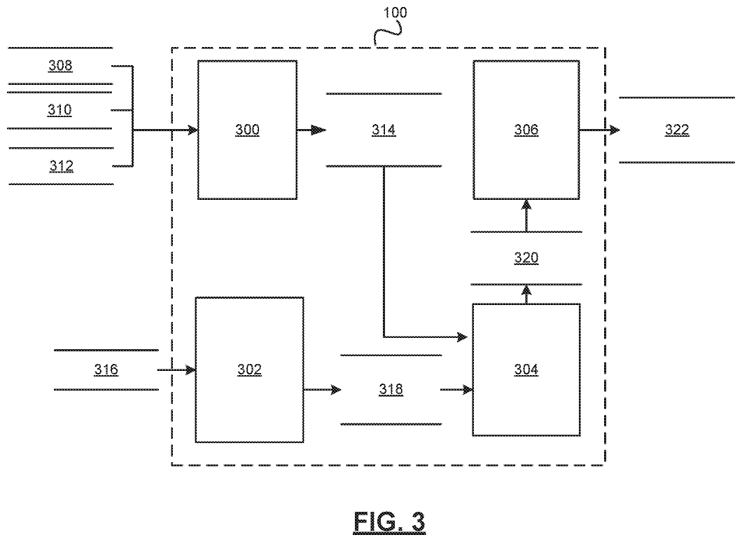

As shown in more detail with regard to FIG. 3 and with continued reference to FIGS. 1 and 2, the object tracking system 100 includes a real-time lane width determination module 300, a lane offset determination module 302, a lane width threshold determination module 304, and in-path object determination module 306.

The real-time lane width determination module 300 determines real-time lane width data 314 that is used to determine lane width thresholds. For example, the real-time lane width determination module 300 receives as input sensor data 308, map data 308, and GPS data 312. When lane information is available for the current location (as indicated by the GPS data 312) as the sensor data 308 and/or the map data 310, the real-time lane width determination module 300 selects the real-time lane width from the received data 308 or 310 based on based on a comparison of the data 308 and 310 to a range of lane widths. In various embodiments, the range is calibratable. For example, when the sensor data 308 falls within the range, the sensor data 308 is selected as the real-time lane width data 314. In another example, when the map data 310 falls within the range, the map data 310 is selected as the real-time lane width data 314.

The lane offset determination module 302 determines offset data 318 that is used to determine the lane width thresholds. For example, the lane offset determination module 302 receives sensor data 316, and the real-time lane width data 314. In various embodiments, the sensor data 316 indicates a measured lateral distance from the center of the vehicle 10 to the lane edge (e.g., the left lane edge). Based on the sensor data 316, the lane offset determination module 302 determines an offset ratio and uses the offset ratio to determine an offset value.

For example, the lane offset determination module 302 computes an offset max ratio by based on a maximum lane width and the real time lane width data 314 (e.g., max/lane width). In another example, the lane offset determination module 302 computes an offset min ratio based on a minimum lane width and the real time lane width data lane width data 314 (e.g., min/lane width). The lane offset determination module 302 then computes the lane offset data 318 by applying the offset ratios to the sensor data 316 and subtracting out half of the real-time lane width data 318.

The lane width threshold determination module 304 determines an in-path lane threshold data 320 that is used to detect objects within the current lane. For example, the lane width threshold determination module 304 receives the real-time lane width data 314, the offset data 318. The lane width threshold determination module 304 applies the offset data 318 to previously computed in-path thresholds (e.g., by subtracting the offset value from the left threshold, and adding the offset to the right threshold). The lane width threshold determination module 304 then limits the threshold width threshold data 320 based on a hysteresis. In various embodiments, the hysteresis is calibratable.

The in-path object determination module 306 determines in-path objects and generates object tracking data 322 based thereon. For example, the in-path object determination module 306 receives the lane width threshold data 320. The in-path object determination module 306 applies the thresholds to in-path determination logic for all targets determined to be within the field of view to determine the object tracking data 322.

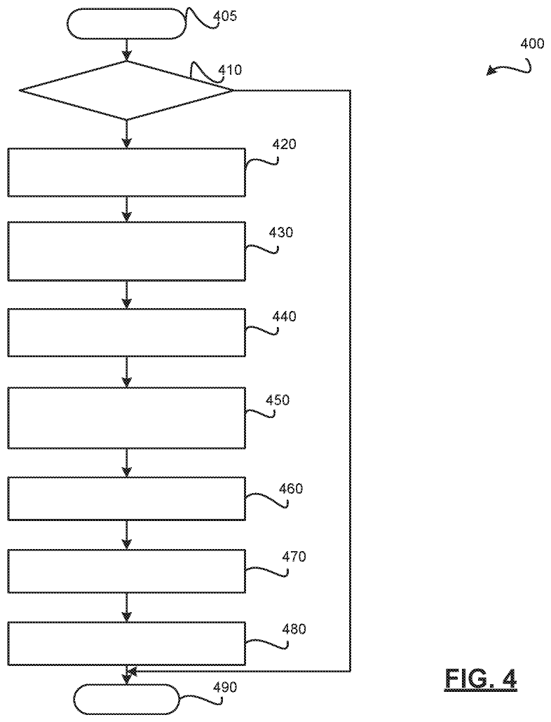

Referring now to FIG. 4 and with continued reference to FIGS. 1-3, a method 400 for determining object tracking data is shown in accordance with embodiments. As can be appreciated, in light of the disclosure, the order of operation within the method 400 is not limited to the sequential execution as illustrated in FIG. 4 but may be performed in one or more varying orders as applicable and in accordance with the present disclosure. In various embodiments, one or more steps of the methods 400 may be removed or added without altering the spirit of the method 400.

In one example, the method may begin at 405. The availability of lane information is confirmed at 410. When lane information is available for the current location from the sensor system and/or the map data, the method continues at 420. Otherwise, the method ends at 490.

At 420, the real-time lane width for the current location is selected for example based on the arbitration method discussed above. The in-lane threshold is computed based on the updated lane width at 430.

The sensor measured lateral distance from the center of the host vehicle to the lane edge is obtained at 440. Thereafter, the offset ratio and offset value are computed based thereon at 450.

The offset value is applied to the previously created in-path thresholds (e.g., by subtracting the offset from the left side and adding the offset to the right side) at 460. The in-path thresholds are then capped to a minimum distance at 470.

The in-path thresholds are applied to in-path determination logic for all targets determined to be within the field of view at 480. Thereafter, the method may end at 490.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method for controlling a vehicle, comprising:
receiving, by a processor, real-time lane width data based on a current location of the vehicle;
computing, by the processor, an in-path threshold based on the real-time lane width;
receiving, by the processor, real-time distance data based on a distance between a center of the vehicle and a lane edge;
computing, by the processor, an offset value based on the real-time distance data;
applying, by the processor, the offset value to the in-path threshold;
tracking, by the processor, a position of objects within the field of view of the vehicle sensor system based on the in-path threshold; and
controlling, by the processor, the vehicle based on the tracking of the objects.

2. The method of claim 1, wherein the real-time lane width data is received from a camera of the vehicle.

3. The method of claim 1, wherein the real-time lane width data is received from a data storage device of the vehicle that stores map data.

4. The method of claim 1, wherein the computing the offset value is further based on an offset ratio and the real-time lane width data.

5. The method of claim 4, further comprising computing the offset ratio based on a maximum lane width and a real-time lane width; and
applying the offset ratio to the real-time distance data to compute the offset value.

6. The method of claim 5, further comprising subtracting half of the real-time lane width data from offset value.

7. The method of claim 4, further comprising computing the offset ratio based on a minimum lane width and a real-time lane width; and
applying the offset ratio to the real-time distance data to compute the offset value.

8. The method of claim 1, further comprising limiting the in-path threshold based on a predefined hysteresis.

9. The method of claim 1, wherein the applying the offset value to the in-path threshold comprises subtracting the offset value from a left in-path threshold.

10. The method of claim 1, wherein the applying the offset value to the in-path threshold comprises adding the offset value to a right in-path threshold.

11. A system for controlling a vehicle, comprising:
a sensor system configured to provide sensor data that includes real-time lane width data;
a data storage system configured to provide map data that includes real-time lane width data; and
a processor configured to receive real-time lane width data based on a current location of the vehicle from at least one of the sensor system and the data storage system, compute an in-path threshold based on the real-time lane width, receive real-time distance data based on a distance between a center of the vehicle and a lane edge, compute an offset value based on the real-time distance data, apply the offset value to the in-path threshold, track a position of objects within the field of view of the vehicle sensor system based on the in-path threshold, control the vehicle based on the tracking of the objects.

12. The system of claim 11, wherein the real-time lane width data is received from a camera of the sensor system.

13. The system of claim 11, wherein the real-time lane width data is received from a data storage system.

14. The system of claim 11, wherein the processor computes the offset value is further based on an offset ratio and the real-time lane width data.

15. The system of claim 14, wherein the processor is further configured to compute the offset ratio based on a maximum lane width and a real-time lane width; and
applying the offset ratio to the real-time distance data to compute the offset value.

16. The system of claim 15, wherein the processor is further configured to subtract a half of the real-time lane width data from offset value.

17. The system of claim 14, wherein the processor is further configured to compute the offset ratio based on a minimum lane width and a real-time lane width; and
applying the offset ratio to the real-time distance data to compute the offset value.

18. The system of claim 11, wherein the processor is further configured to limit the in-path threshold based on a predefined hysteresis.

19. The system of claim 11, wherein the applying the offset value to the in-path threshold comprises subtracting the offset value from a left in-path threshold.

20. The system of claim 11, wherein the processor applies the offset value to the in-path threshold by adding the offset value to a right in-path threshold.
